(19) United States
(12) Patent Application Publication
(10) Pub. No.: US 2013/0115522 A1
(43) Pub. Date: May 9, 2013

(54) Manufacture of LiPO2F2

(71) Applicants: Placido Garcia-Juan, Hannover (DE); Alf Schulz, Wedemark (DE)

(72) Inventors: Placido Garcia-Juan, Hannover (DE); Alf Schulz, Wedemark (DE)

(73) Assignee: SOLVAY SA, Brussels (BE)

(21) Appl. No.: 13/808,241

(22) PCT Filed: Jun. 30, 2011
(86) PCT No.: PCT/EP2011/061026

§ 371 Date: Jan. 3, 2013

(30) Foreign Application Priority Data
Jul. 8, 2010 (EP) 10168886.9

(51) Int. Cl. H01M 10/0564; C01D 15/00

(52) U.S. Cl. CPC H01M 10/0564; C01D 15/00
USPC 429/338; 423/301; 429/199; 429/342; 429/339; 429/341

(57) ABSTRACT

LiPO₂F₂ is manufactured by the reaction of compounds of the general formula (I), LiXYPO₄, wherein X and Y are the same or different and denote H or Li, with anhydrous HF forming a reaction mixture comprising LiPO₂F₂. Preferably, LiH₂PO₄ is applied as starting material. LiPO₂F₂ can be isolated from the reaction mixture by extraction with dimethyl carbonate or propylene carbonate.

The present invention claims benefit of European patent application No. 10168886.9 filed on Jul. 8, 2010 the whole content of this application being incorporated herein by reference for all purposes.

The present invention concerns a method for the manufacture of LiPO₂F₂ and a solution of LiPO₂F₂ in certain solvents, e.g. in propylene carbonate.

LiPO₂F₂ is useful as an additive for lithium ion batteries. Thus, WO 2008/111367 discloses how to manufacture a mixture of LiPF₆ and LipO₂F₂ from a halide other than a fluoride, LiPF₆ and water. The resulting salt mixture, dissolved in aprotic solvents, is used as an electrolyte solution for lithium ion batteries. EP-A-2 061 115 describes the manufacture of LipO₂F₂ from P₂O₃F₄ and Li compounds as state of the art, and the manufacture of LipO₂F₂ from LiPF₆ and compounds with a Si—O—Si bond, e.g. siloxanes. The product contains LiPF₆.

Object of the present invention is to provide LipO₂F₂ in a technically feasible manner and to provide solutions comprising LipO₂F₂ in a high concentration. A further object of the present invention is to provide pure LipO₂F₂ in a technically feasible manner. These objects and other objects are achieved by the invention as outlined in the patent claims.

According to one aspect of the present invention, LipO₂F₂ is manufactured by the reaction of compounds of the general formula (I), LiXYPO₄, wherein X and Y are the same or different and denote H or Li, with anhydrous HF to form a reaction mixture comprising LipO₂F₂. Preferably, X and Y are H.

If the compound Li₃PO₄ is applied as a starting material, 4 mol of HF are needed stoichiometrically to convert all Li₃PO₄ into LiPO₂F₂, water and LiF. For this starting material, the ratio of HF:Li₃POF₄ is preferably equal to or greater than 6:1. Preferably, it is equal to or lower than 20:1. Applying Li₃PO₄ as starting material leads to the formation of LiF as by-product.

LiH₂PO₄ is the preferred starting material of formula (I). This is the preferred embodiment of the method of the invention. 2 mol of HF are stoichiometrically needed to convert all of the LiH₂PO₄ to LiPO₂F₂ and water. Preferably, in this embodiment, the molar ratio of HF:LiH₂PO₄ is equal to or greater than 3:1. More preferably, the molar ratio of HF:LiH₂PO₄ is equal to or greater than 5:1. Preferably, the molar ratio of HF:LiH₂PO₄ is equal to or lower than 25:1. More preferably, the molar ratio of HF: LiH₂PO₄ is equal to or lower than 20:1.

Preferably, the reaction is performed at least for a part of its duration under pressure. This serves to keep the HF in the liquid phase. Preferably, the reaction is performed under autogenous pressure, especially in an autoclave.

The reaction between LiH₂PO₄ and HF is preferably performed at a temperature equal to or higher than 100° C. The reaction can be performed at lower pressure, but possibly the reaction time could be too long. It is preferably performed at a temperature equal to or lower than 220° C., more preferably, at a temperature equal to or lower than 180° C. Preferably, the temperature is kept in a range of 100 to 180° C.

The reaction time is selected such that the desired degree of conversion is achieved. Often, a reaction time of 10 minutes to 3 hours gives good results.

After the reaction under pressure, the reaction mixture is preferably subjected to a pressureless post treatment. In this post treatment, the pressure is brought to ambient pressure by releasing gaseous compounds. The gaseous components (mostly unreacted HF) are passed through a washer or adsorbent to remove the HF or condensed for reuse. The remaining liquid reaction mixture is heated, preferably to a temperature equal to or higher than 160° C., and more preferably, to a temperature equal to or higher than 180° C. Preferably, the post treatment is performed at a temperature equal to or lower than 220° C.

Preferably, the post treatment is performed at a temperature in the range of 160 to 220° C., and more preferably, at a temperature in the range of greater than 180° C. and equal to or lower than 220° C.

The post treatment time is preferably equal to or longer than 10 minutes. It is preferably equal to or shorter than 2 hours.

The reaction mixture often contains LiPO₂F₂ and Li₂PO₃F and also LiF. The reaction mixture does not contain LiPF₆. Thus, the method of the invention yields a LiPO₂F₂ which is different from known LiPO₂F₂.

If it is desired to isolate LiPO₂F₂ and Li₂PO₃F from any LiF, polar aprotic solvents can be applied. For example, dialkyl carbonates are suitable for this purpose. Other solvents are acetone, isopropanol, tetrahydrofurane, ethyl acetate, acetonitrile, and diethyl carbonate. If it is desired to isolate selectively LiPO₂F₂, propylene carbonate was identified as very suitable solvent because LiPO₂F₂ is soluble therein, and Li₂PO₃F and also LiF are not. Other very suitable solvents are diethyl carbonate, a mixture of dimethyl carbonate and propylene carbonate, acetonitrile, dimethoxyethane and acetone. The solubility of LiPO₂F₂ in these solvents at ambient temperature is compiled in the following table 1.

TABLE 1
Solubility of LiPO₂F₂ in certain solvents

| Solvent | Solubility of LiPO₂F₂ [g/100 g solvent] |
|---|---|
| Diethyl carbonate | 0.4 |
| Dimethyl carbonate/propylene | 0.4 |
| carbonate (1:1 v/v) | |
| Acetonitrile | 2.8 |
| Dimethoxyethane | 37 |
| Acetone | 20 |

The solubility of LiPO₂F₂ in acetonitrile and especially in dimethoxyethane and acetone is remarkably high. Acetone is not very well suited as a solvent for Li ion batteries, but it may advantageously be used for the purification of LiPO₂F₂ because it has a very high solubility for LiPO₂F₂ and a very low solubility for LiF. Thus, mixtures comprising LiF and LiPO₂F₂ can easily be separated by dissolving the LiPO₂F₂ in acetone and filtration to remove solid LiFLiPO₂F₂ can be recovered from its solutions in acetone, for example, by evaporation of the acetone.

The solubility of LiPO₂F₂ in dimethoxyethane is even higher than in acetone. Dimethoxyethane has even be considered as solvent or solvent additive for Li ion batteries. Thus, dimethoxyethane—which also dissolves LiF at most in neglectable amounts—can be used for the purification of LiPO₂F₂ as described above in view of the use of acetone, and it can even be applied to raise the solubility of LiPO₂F₂ in Li ion battery solvents.

Solutions of LiPO₂F₂ in dimethyl carbonate, propylene carbonate and mixtures thereof—which once again dissolve LiF at most in neglectable amounts—can be used for the purification of compositions, e.g. mixtures or solids like precipitates, containing LiF and LiPO₂F₂.

Solutions comprising or consisting of LiPO₂F₂ and at least one solvent selected from dimethyl carbonate, propylene carbonate, dimethoxyethane, acetonitrile and acetone and mixtures therof are also an aspect of the present invention. Preferably, these solvents are essentially freee of LiF. Preferably, the content of LiF is equal to or lower than 0.01 g per liter of the solution. Preferably, the solutions are essentially free of LiPF₆. More preferably, the content of LiPF₆ is equal to or lower than 0.1 g/liter of the solution, still more preferably, equal to or lower than 0.01 g per liter of the solution.

Preferred solutions are compiled in table 2.

TABLE 2
Solutions of LiPO₂F₂ in certain solvents

| | | Especially | |
|---|---|---|---|
| | Preferred | preferred | |
| | amount of | amount of | Preferred amounts |
| Solvent | LiPO₂F₂ | LiPO₂F₂ | of LiF and LiPF₆ |
| Diethyl carbonate | 0.2 g/100 g | 0.3 g/100 g | LiF: <0.01 g/100 g |
| | solvent- | solvent- | solvent |
| | saturation | saturation | LiPF6: <0.1 g/ |
| | concentration* | concentration* | 100 g solvent |
| Dimethyl | 0.2 g/100 g | 0.3 g/100 g | LiF: <0.01 g/ |
| carbonate/propylene | solvent- | solvent- | 100 g solvent |
| carbonate (1:1 v/v) | saturation | saturation | LiPF6: <0.1 g/ |
| | concentration* | concentration* | 100 g solvent |
| Acetonitrile | 1.4 g/100 g | 2.0 g/100 g | LiF: <0.01 g/ |
| | solvent- | solvent- | 100 g solvent |
| | saturation | saturation | LiPF6: <0.1 g/ |
| | concentration* | concentration* | 100 g solvent |
| | 20 g/100 g | 25 g/100 g | LiF: <0.01 g/ |
| Dimethoxyethane | solvent- | solvent- | 100 g solvent |
| | saturation | saturation | LiPF6: <0.1 g/ |
| | concentration* | concentration* | 100 g solvent |
| Acetone | 10 g/100 g | 15 g/100 g | LiF: <0.01 g/ |
| | solvent- | solvent- | 100 g solvent |
| | saturation | saturation | LiPF6: <0.1 g/ |
| | concentration* | concentration* | 100 g solvent |

*The saturation concentration, as measured at 20° C.

More preferably, the solution of LipO₂F₂ in dimethyl carbonate contains 0.2 g-0.4 g LiPO₂F₂ per 100 g solvent. Preferably, in this solution, the content of LiF is <0.01 g/100 g solvent and the content of LiPF₆ is <0.1 g/100 g solvent.

More preferably, the solution of LiPO₂F₂ in dimethyl carbonate/propylene carbonate 1:1 (v/v) contains 0.2 g-0.4 g LiPO₂F₂ per 100 g solvent. Preferably, in this solution, the content of LiF is <0.01 g/100 g solvent and the content of LiPF₆ is <0.1 g/100 g solvent.

More preferably, the solution of LipO₂F₂ in acetonitrile contains 1.4 g-2.8 g LiPO₂F₂ per 100 g solvent. Preferably, in this solution, the content of LiF is <0.01 g/100 g solvent and the content of LiPF₆ is <0.1 g/100 g solvent.

More preferably, the solution of LiPO₂F₂ in dimethoxyethane contains 20 g-37 g LiPO₂F₂ per 100 g solvent. Preferably, in this solution, the content of LiF is <0.01 g/100 g solvent and the content of LiPF₆ is <0.1 g/100 g solvent.

More preferably, the solution of LiPO₂F₂ in acetone contains 10 g-20 g LiPO₂F₂ per 100 g solvent. Preferably, in this solution, the content of LiF is <0.01 g/100 g solvent and the content of LiPF₆ is <0.1 g/100 g solvent.

Especially preferably, these 5 solutions indicated as “more preferably” consist of said solvent and LiPO₂F₂ in said amounts.

A preferred solution contains or consists of propylene carbonate and LiPO₂F₂. In view of this preferred solution, this aspect of the present invention will be further explained.

The solution of LiPO₂F₂ dissolved in propylene carbonate can be separated from the non-dissolved solids of the reaction mixture. For example, the solution can be passed through a filter, or it can be decanted. The solution is useful as such, e.g. as additive for the manufacture of electrolyte solutions for lithium ion batteries.

If desired, the solution of dissolved LiPO₂F₂ in propylene carbonate is subjected to a separation treatment to separate propylene carbonate from pure solid LiPO₂F₂. For example, propylene carbonate can be removed by evaporation; in view of the high boiling point of propylene carbonate of about 240° C., this evaporation is preferably performed under vacuum. The isolated LiPO₂F₂ can be used as additive for the manufacture of lithium ion batteries. The advantage of using propylene carbonate as solvent is that the dissolved LiPO₂F₂ can be isolated in crystalline form. Other solvents yielded an amorphous product.

The crystalline LiPO₂F₂ obtained in the process of the present invention is free of LiPF₆.

The solution of LiPO₂F₂ in propylene carbonate contains, under standard conditions (25° C., 1 Bara), up to about 3% by weight of LiPO₂F₂ relative to the total weight of the solution of LiPO₂F₂ in propylene carbonate. It is known for example from WO 2008/111367 that LiPO₂F₂ is suitable as additive for lithium ion batteries. It is also known that propylene carbonate is a solvent useful for the manufacture of lithium ion batteries. Thus, the solution of LiPO₂F₂ in propylene carbonate as provided by the invention is suitable as additive composition for lithium ion batteries because it can provide both LiPO₂F₂ and solvent. To provide an electrolyte solution for lithium ion batteries, the solution of LiPO₂F₂ in propylene carbonate can be mixed with another electrolyte salt and another solvent or solvents. For example, an electrolyte salt like LiPF₆, LiAsF₆, LiClO₄, LiCF₃SO₃, LiN(SO₂CF₃)₂, LiN(SO₂C₂F₅)₂, LiN(SO₂-i-C₃F₇)₂, LiN(SO₂-n-C₃F₇)₂, LiBC₄O₈ (“LiBOB”), or Li(C₂F₅)PF₃, and one or more further solvents, such as dialkyl carbonates, e.g. dimethyl carbonate or ethyl carbonate, alkylene carbonate, e.g. ethylene carbonate, fluorinated solvents, e.g. mono-, di-, tri- and/or tetrafluoroethylene carbonate, and/or any other desired solvents or additives are combined with the solution of LiPO₂F₂ in propylene carbonate in a vessel and homogenized to provide an electrolyte solution suitable for the manufacture of lithium ion batteries.

Consequently, the solution of LiPO₂F₂ in propylene carbonate is a valuable intermediate and another especially preferred aspect of the present invention.

In one embodiment, the solution consists essentially of LiPO₂F₂ and propylene carbonate. The term “essentially” preferably denotes that the solution contains equal to or more than 95% by weight, preferably equal to or more than 98% by weight of LiPO₂F₂ and propylene carbonate. The content of LiPO₂F₂ in the solution is preferably equal to or greater than 0.1% by weight. Preferably, the concentration of LipO₂F₂ is equal to or lower than the maximum concentration in propylene carbonate which can be achieved at a given temperature. Most preferably, the concentration of LiPO₂F₂ in the solution is equal to or lower than 3% by weight of the total weight of the solution. For many purposes, it will be desirable that the concentration of LiPO₂F₂ in the solution be as high as possible, e.g. equal to or greater than 2% by weight up to the solubility limit. Often, the concentration will be in the range of about 2 to about 3% by weight of the total weight of the solution.

In this embodiment, the solution consists preferably of 97 to 98% by weight of propylene carbonate and 2 to 3% by weight of LiPO₂F₂.

In another embodiment, the solution comprises LiPO₂F₂, propylene carbonate and at least one further component selected from the group consisting of electrolyte salts and solvents for lithium ion batteries. The at least one further electrolyte salt is preferably selected from the group consisting of LiPF₆, LiAsF₆, LiClO₄, LiCF₃SO₃, LiN(SO₂CF₃)₂, LiN(SO₂C₂F₅)₂, LiN(SO₂-i-C₃F₇)₂ LiN(SO₂-n-C₃F₇)₂, LiBC₄O₈ (“LiBOB”), or Li(C₂F₅)PF₃; the concentration of the at least one further electrolyte salt or, if several further electrolyte salts are contained, is selected preferably such that the total concentration of Li salts is preferably about 0.9 to 1.1 molar. LiPF₆ is the preferred further electrolyte salt; it is preferably contained in concentration of 0.62 to 0.9 mol/liter when LiPO₂F₂ is contained in an amount of about 0.2 to 0.28 mol/liter wherein the sum of the lithium salts adds up to a total molar concentration of about 0.9 to 1.1 mol/liter.

The at least one further solvent is selected among those solvents which are known in the art. Some useful types of solvents are given in the publication of M. Ue et al. in J. Electrochem. Soc. Vol. 141 (1994), pages 2989 to 2996. Lactones, formamides, pyrrolidinones, oxazolidinones, nitroalkanes, N,N-substituted urethanes, sulfolane, dialkyl sulfoxides, dialkyl sulfites, and trialkylphosphates or alkoxyesters, as described in DE-A 10016816, are useful solvents.

Alkyl carbonates and alkylene carbonates are especially suitable, for example, ethylene carbonate, dimethyl carbonate, methyl ethyl carbonate, diethyl carbonate, and propylene carbonate, see EP-A-0 643 433. Pyrocarbonates are also useful, see U.S. Pat. No. 5,427,874. Alkyl acetates, N,N-disubstituted acetamides, sulfoxides, nitriles, glycol ethers and ethers are useful, too, see EP-A-0 662 729. Often, mixtures of these solvents are applied. Dioxolane is a useful solvent, see EP-A-0 385 724. For lithium bis-(trifluoromethansulfonyl)imide, 1,2-bis-(trifluoracetoxy)ethane and N,N-dimethyl trifluoroacetamide were applied as solvent, see ITE Battery Letters Vol. 1 (1999), pages 105 to 109. In the foregoing, the term “alkyl” preferably denotes saturated linear or branched C1 to C4 alkyl groups. Other highly suitable additional solvents are dimethoxyethane and nitriles and dinitriles, especially acetonitrile. Also ketones, for example, acetone, are very good solvents; but those ketones with an α-H atom are not preferred solvents for Li ion batteries. But acetone dissolves a very high amount of LiPO₂F₂, and thus can be applied, for example, during purification steps.

Fluorosubstituted organic compounds are also suitable as the at least one further solvent.

Examples of the halogenated carbonic esters include halogenated ethylene carbonates, halogenated dimethyls, halogenated ethyl methyl carbonates, and halogenated diethyl carbonates. The term “halogenated” denotes especially preferably “fluorinated”.

Preferred fluorosubstituted solvents are fluoro ethylene carbonate, 4,4-difluoro ethylene carbonate, cis- and trans 4,5-difluoro ethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate.

Examples of the dimethyl carbonate derivatives include fluoromethyl methyl carbonate, difluoromethyl methyl carbonate, trifluoromethyl methyl carbonate, bis(fluoromethyl) carbonate, bis(difluoro)methyl carbonate, and bis(trifluoro)methyl carbonate.

Examples of the ethyl methyl carbonate derivatives include 2-fluoroethyl methyl carbonate, ethyl fluoromethyl carbonate, 2,2-difluoroethyl methyl carbonate, 2-fluoroethyl fluoromethyl carbonate, ethyl difluoromethyl carbonate, 2,2,2-trifluoroethyl methyl carbonate, 2,2-difluoroethyl fluoromethyl carbonate, 2-fluoroethyl difluoromethyl carbonate, and ethyl trifluoromethyl carbonate.

Examples of the diethyl carbonate derivatives include ethyl (2-fluoroethyl) carbonate, ethyl (2,2-difluoroethyl) carbonate, bis(2-fluoroethyl) carbonate, ethyl (2,2,2-trifluoroethyl) carbonate, 2,2-difluoroethyl 2′-fluoroethyl carbonate, bis(2,2-difluoroethyl) carbonate, 2,2,2-trifluoroethyl 2′-fluoroethyl carbonate, 2,2,2-trifluoroethyl 2′,2′-difluoroethyl carbonate, and bis(2,2,2-trifluoroethyl) carbonate.

Fluoro ethylene carbonate, 4-(fluoromethyl)-ethylene carbonate, 4,4-difluoroethylene carbonate, and cis- and trans-4,5-difluoroethylene carbonate and their mixtures are especially preferred.

Carbonic esters having both an unsaturated bond and a fluorine atom (hereinafter abbreviated to as “fluorinated unsaturated carbonic ester”) can also be used as the particular carbonic ester. The fluorinated unsaturated carbonic esters include any fluorinated unsaturated carbonic esters that do not significantly impair the advantages of the present invention.

Examples of the fluorinated unsaturated carbonic esters include vinylene carbonate derivatives, ethylene carbonate derivatives substituted by a substituent having an aromatic ring or a carbon-carbon unsaturated bond, and allyl carbonates.

Examples of the vinylene carbonate derivatives include fluorovinylene carbonate, 4-fluoro-5-methylvinylene carbonate and 4-fluoro-5-phenylvinylene carbonate.

Examples of the ethylene carbonate derivatives substituted by a substituent having an aromatic ring or a carbon-carbon unsaturated bond include 4-fluoro-4-vinylethylene carbonate, 4-fluoro-5-vinylethylene carbonate, 4,4-difluoro-4-vinylethylene carbonate, 4,5-difluoro-4-vinylethylene carbonate, 4-fluoro-4,5-divinylethylene carbonate, 4,5-difluoro-4,5-divinylethylene carbonate, 4-fluoro-4-phenylethylene carbonate, 4-fluoro-5-phenylethylene carbonate, 4,4-difluoro-5-phenylethylene carbonate, 4,5-difluoro-4-phenylethylene carbonate and 4,5-difluoro-4,5-diphenylethylene carbonate.

Examples of the phenyl carbonates include fluoromethyl phenyl carbonate, 2-fluoroethyl phenyl carbonate, 2,2-difluoroethyl phenyl carbonate and 2,2,2-trifluoroethyl phenyl carbonate.

Examples of the vinyl carbonates include fluoromethyl vinyl carbonate, 2-fluoroethyl vinyl carbonate, 2,2-difluoroethyl vinyl carbonate and 2,2,2-trifluoroethyl vinyl carbonate.

Examples of the allyl carbonates include fluoromethyl allyl carbonate, 2-fluoroethyl allyl carbonate, 2,2-difluoroethyl allyl carbonate and 2,2,2-trifluoroethyl allyl carbonate.

The amount of fluoro substituted carbonates is preferably in the range of 0.1 to 20% by weight, relative to the total weight of the electrolyte solution.

In such mixtures, the content of LiPO₂F₂ is preferably 2 to 3% by weight, the content of other Li salts is such that the sum of lithium salts is preferably about 0.9 to 1.1 molar, the content of propylene carbonate is preferably 1 to 50% by weight, and the remainder to 100% by weight is constituted by the at least one other solvent; these amounts refer to the total weight of the salt/solvent mixture set to 100% by weight and by mol, respectively.

The solution of LiPO₂F₂ in propylene carbonate can be produced by dissolving LiPO₂F₂ if desired, further salts and s/or solvents, as described above are added.

The advantage of the process of the invention is among others that pure LiPO₂F₂ can be obtained from cheap starting materials.

Should the disclosure of any of the patents, patent applications, and publications that are incorporated herein by reference conflict with the present description to the extent that it might render a term unclear, the present description shall take precedence.

The following examples will describe the invention in further detail without the intention to limit it.

### EXAMPLE 1

### Synthesis and Isolation of LiPO₂F₂

### Example 1.1: Synthesis of LiPO₂F₂

LiH₂PO₄ (0.24 mol) and HF (2.4 mol) were given into an autoclave, heated therein to a temperature of about 140° C. and kept at that temperature for about 2 hours. The autoclave is opened and brought to ambient pressure; gaseous products are released from the autoclave. The remaining reaction mixture was brought to about 200° C. and kept at that temperature for about one hour. The raw reaction product was analyzed by XRD (Roentgen diffractometry). It consists of a mixture of LiF, LiPO₂F₂ and Li₂PO₃F.

### Example 1.2: Isolation of LiPO₂F₂

Propylene carbonate was added to a part of the salt mixture obtained in example 1.1 and the resulting solid/liquid composition was stirred for 30 minutes. The liquid was separated from any remaining solids. The obtained solution consisted of LiPO₂F₂ and propylene carbonate.

The solvent was removed from the solution at reduced pressure. The resulting solid was identified by F-NMR and P-NMR as pure LiPO₂F₂.

### Example 1.3: Isolation of a Mixture of LiPO₂F₂ and Li₂PO₃F

Example 1.2 was repeated, but diethyl carbonate was applied as solvent. After separation from undissolved solids, the solvent was removed, and a mixture of LiPO₂F₂ and Li₂PO₃F was obtained.

### EXAMPLE 2

### Manufacture of LiPO₂F₂ from Li₃PO₄

Example 1 was repeated, but Li₃PO₄ was applied as starting material. The resulting reaction mixture contains a greater amount of LiF compared to the reaction mixture of example 1.1. LiPO₂F₂ was isolated in crystalline form by extraction of the reaction mixture with propylene carbonate as solvent and removing the solvent in vacuo.

### EXAMPLE 3

### Manufacture of LiPO₂F₂ from Li₃PO₄

Example 2 is repeated. LiPO₂F₂ is isolated in crystalline form by extraction of the reaction mixture with dimethyl carbonate as solvent and removing the solvent in vacuo.

Analytical data of crystalline LiPO₂F₂:
XRD:2-Theta values: 21.5 (strong); 22.0; 23.5; 27.0 (strong); 34.2; 43.2
¹⁹F-NMR (470.94 MHz; solution in D-acetone): −84.25 ppm (doublet, the 2 lines at −83.3 ppm and −85.2 ppm, coupling constant 926 Hz)
³¹P-NMR (202,61 MHz; solution in D-acetone): −19,6 ppm (triplet, the 3 lines at −12.3 ppm, −16.9 ppm and −21.5 ppm; coupling constant 926 Hz).

Melting point: the melting point cannot be determined because the compound decomposes at temperatures above about 350° C.

For comparison: for HPO₂F₂ (the corresponding free acid; prepared as hydrolysis product of LiPF₆, further comprising H₂PO₃F, measured in a mixture of propylene carbonate and dimethyl carbonate, with a few drops of water), a doublet at −83.3 ppm with a coupling constant of 975 Hz was reported for the ¹⁹F-NMR spectrum, and a triplet at −21.6 ppm with a coupling constant of 975 Hz in the ³¹P-NMR spectrum was reported in the literature.

### EXAMPLE 4

### Manufacture of a Solution of Pure LiPO₂F₂ in Propylene Carbonate

Under inert gas (nitrogen), pure LiPO₂F₂ was dissolved in propylene carbonate at about 20° C. such that a solution is obtained comprising about 2.75% by weight of LiPO₂F₂.

### EXAMPLE 5

### Manufacture of Solutions of LiPO₂F₂ in Other Solvents

Under inert gas (nitrogen), pure LiPO₂F₂ was dissolved in the respective solvent or solvent mixture at about 20° C. such that a solution containing the amounts of dissolved LiPO₂F₂ given in the following table 3 were achieved. The data for solution No. 1 was taken from example 4, the data for solutions No. 2 to 6 of table 3 correspond to those of table 1.

TABLE 3
Solutions of LiPO₂F₂ in certain solvents

| | | Solubility of LiPO₂F₂ |
|---|---|---|
| Solution N° | Solvent | [g/100 g solvent] |
| 1 | Propylene carbonate | 2.75% by weight* |
| 2 | Diethyl carbonate | 0.4 |
| 3 | Dimethyl | 0.4 |
| | carbonate/propylene | |
| | carbonate (1:1 v/v) | |
| 4 | Acetonitrile | 2.8 |
| 5 | Dimethoxyethane | 37 |
| 6 | Acetone | 20 |

*Data taken from example 4

### EXAMPLE 6

### Battery Electrolytes Suitable for Li Ion Batteries

1. The solution No. 1 of table 3 is mixed with monofluoroethylene carbonate and LiPF₆ is dissolved in the resulting battery electrolyte such that the total content of Li salts is 1 molar and the amount of monofluoroethylene carbonate is about 4% by weight of the total weight of the resulting battery electrolyte.

2. The solution No. 2 of table 3 is mixed with monofluoroethylene carbonate and LiPF₆ is dissolved in the resulting battery electrolyte such that the total content of Li salts is 1 molar and the amount of monofluoroethylene carbonate is about 4% by weight o the total weight of the resulting battery electrolyte.

3. The solution No. 3 of table 3 is mixed with monofluoroethylene carbonate and LiPF₆ is dissolved in the resulting battery electrolyte such that the total content of Li salts is 1 molar and the amount of monofluoroethylene carbonate is about 4% by weight o the total weight of the resulting battery electrolyte.

4. The solution No. 4 of table 3 is mixed with monofluoroethylene carbonate and LiPF₆ is dissolved in the resulting battery electrolyte such that the total content of Li salts is 1 molar and the amount of monofluoroethylene carbonate is about 4% by weight o the total weight of the resulting battery electrolyte.

5. The solution No. 4 of table 3 is mixed with propylene carbonate and monofluoroethylene carbonate and LiPF₆ is dissolved in the resulting battery electrolyte such that the total content of Li salts is 1 molar and the amount of monofluoroethylene carbonate is about 4% by weight of the total weight of the resulting battery electrolyte. The content of solution No. 4 is added in an amount such that it corresponds to about 20% by volume of the total volume of the resulting battery electrolyte.

6. The solution No. 5 of table 3 is mixed with monofluoroethylene carbonate and LiPF₆ is dissolved in the resulting battery electrolyte such that the total content of Li salts is 1 molar and the amount of monofluoroethylene carbonate is about 4% by weight o the total weight of the resulting battery electrolyte.

5. The solution No. 4 of table 3 is mixed with propylene carbonate and monofluoroethylene carbonate and LiPF₆ is dissolved in the resulting battery electrolyte such that the total content of Li salts is 1 molar and the amount of monofluoroethylene carbonate is about 4% by weight of the total weight of the resulting battery electrolyte. The content of solution No. 4 is added in an amount such that it corresponds to about 20% by volume of the total volume of the resulting battery electrolyte.

7. 20 ml of the solution No. 5 of table 3 is mixed with 3 ml of monofluoroethylene carbonate and 80 ml of propylene carbonate, and LiPF₆ is dissolved in the resulting battery electrolyte such that the total content of Li salts is 1 molar.

8.20 ml of the solution No. 5 of table 3 is mixed with 3 ml of monofluoroethylene carbonate and 80 ml of dimethyl carbonate/propylene carbonate with a ratio of 1:1 (v/v), and LiPF₆ is dissolved in the resulting battery electrolyte such that the total content of Li salts is 1 molar.

### EXAMPLE 6

### Use of Dimethoxyethane and Acetone for the Purification of LiPO₂F₂

1. 20 g of a mixture comprising 95% by weight of LiPO₂F₂ and 5% by weight of LiF is extracted with 120 ml of acetone at about 20° C. Remaining solid is filtered off, and the liquid phase is treated in a vacuum to evaporate the solvent. Pure LiPO₂F₂ is obtained.

2.20 g of a mixture comprising 95% by weight of LiPO₂F₂ and 5% by weight of LiF is extracted with 60 ml of dimethoxyethane at about 20° C. Remaining solid is filtered off, and the liquid phase is treated in a vacuum to evaporate the solvent. Pure LiPO₂F₂ is obtained.

1. A method for the manufacture of LiPO₂F₂, comprising a reaction of a compound of the general formula (I), LiXYPO₄, wherein X and Y are the same or different and are H or Li, with anhydrous HF to form a reaction mixture comprising LiPO₂F₂.

2. The method of claim 1, wherein X and Y are H.

3. The method of claim 2, wherein the molar ratio of HF:LiH₂PO₄ is equal to or greater than 3:1.

4. The method of claim 1, wherein the reaction is performed at least partially under pressure.

5. The method of claim 4, wherein the reaction performed under pressure is followed by a pressureless post treatment.

6. The method of anyone of claim 4, wherein the reaction is performed under pressure at a temperature in the range of from 100 to 180° C.

7. The method of claim 5, wherein the post treatment is performed at a temperature in the range of from 160 to 220° C.

8. The method of claim 1, wherein said LiPO₂F₂ formed in said reaction is dissolved in propylene carbonate to form a solution of LiPO₂F₂ dissolved in said propylene carbonate.

9. The method of claim 8, wherein said solution of LiPO₂F₂ dissolved in said propylene carbonate is separated from said reaction mixture.

10. The method of claim 9, wherein said solution of LiPO₂F₂ dissolved in said propylene carbonate is subjected to a separation treatment to separate said propylene carbonate and to isolate solid LiPO₂F₂.

11. The method of claim 10, wherein said separation treatment comprises a step of evaporation of said propylene carbonate.

12. A solution comprising LiPO₂F₂ dissolved in propylene carbonate.

13. The solution of claim 12, consisting essentially of LiPO₂F₂ dissolved in propylene carbonate.

14. A solution comprising LiPO₂F₂ dissolved in a solvent selected from the group consisting of diethyl carbonate, dimethyl carbonate, propylene carbonate, acetonitrile, dimethoxyethane, acetone, and mixtures thereof.

15. The solution of claim 12, wherein the content of LiPO₂F₂ in said solution is from about 50% of the saturation concentration at 20° C. to the saturation concentration at 20° C.

16. The solution of claim 12, being essentially free of LiF.

17. The solution of claim 12, being essentially free of LiPF₆.

18. The solution of claim 14, comprising LiPO₂F₂ dissolved in a mixture of dimethyl carbonate and propylene carbonate.
